(19) United States
(12) Patent Application Publication
(10) Pub. No.: US 2002/0046251 A1
(43) Pub. Date: Apr. 18, 2002

(54) Streaming memory controller

(75) Inventor: Shepard L. Siegel, Auburn, NH (US)

Correspondence Address: WEINGARTEN, SCHURGIN, GAGNEBIN & LEBOVICI LLP, TEN POST OFFICE SQUARE, BOSTON, MA, 02109, US

(73) Assignee: DATACUBE, INC.

(21) Appl. No.: 09/874,685

(22) Filed: Jun. 5, 2001

Related U.S. Application Data
(63) Continuation-in-part of application No. 09/803,379, filed on Mar. 9, 2001.

(51) Int. Cl. G06F 15/167

(52) U.S. Cl. 709/213

(57) ABSTRACT

A streaming memory controller has a time-division multiplexed interface to sources and destinations of data and a streaming interface to a memory. A unified address generator with look-aside registers is used to provide addresses for the memory. Each source and destination is identified by a context code that is used to index into a table of parameters. A processor loads initial values for the parameters that are then used by the unified address generator to access the appropriate area of memory for the context. Buffers hold data for read and write contexts. An arbiter specifies the context having the greatest requirement for memory access based on the context's buffer status. A sequencer sends streams of data for a specified context to memory until the interrupted by the arbiter.

### REFERENCE TO RELATED APPLICATIONS

This patent application is a continuation in part of patent application Ser. No. 09/803,379 filed Mar. 9, 2001 and claims priority under 35 U.S.C. §120 to that application, which claims priority under 35 U.S.C. §119(e) to provisional patent application Ser. No. 60/188,377 filed Mar. 10, 2000. The disclosures of these applications are incorporated herein by reference.

### STATEMENT REGARDING FEDERALLY SPONSORED RESEARCH OR DEVELOPMENT

### NA

### BACKGROUND OF THE INVENTION

The present invention relates generally to memory controllers and specifically to streaming memory controllers that organize data coming from multiple sources.

There are many applications where significant volumes of data need to be stored in and retrieved from memory. The data to be stored or retrieved can be randomly dispersed throughout the memory or can have a sequential relationship. DMA transfers, serial transfers and video image transfers are all examples of sequential transfers. These sequential transfers are characterized by the fact the once a starting address is known, subsequent addresses can be inferred. Address-inferred data transfers have the advantage that memory address signals do not have to be controlled in conjunction with the data transfer. Techniques have been developed to facilitate high speed data transfers of address-inferred data.

When the data to be written into memory comes from multiple sources, access to the memory must be managed. A system that incorporates multiple parallel write and read ports to one memory is simple to manage but becomes impractical as the number of ports increases. The data lines for each port make connection to the memory cumbersome. As memories have become smaller, the issue of connection management has limited the utility of the multi-port solution.

When multiple ports cannot be connected to a single memory, the system can incorporate multiple memories each accessed by a limited set of clients. For a system performing a fixed function, this solution is not limiting, but when the data in memory is needed for a variety of applications, further logic has been needed to provide sufficient flexibility. One such set of logic is a non-blocking crosspoint switch. The crosspoint switch allows a generalized interconnect between memory and logic elements, at the expense of silicon and power. However, as the number of sources and destinations increases, the size of the crosspoint increases geometrically, rapidly becoming impractical as the space and cost of wire, bussing, buffering and switching matrix increase.

Each time separate memories are used they must be sized. Sizing the memory too small precludes holding all the data for a particular application, such as an image, in the memory. Sizing a memory too large either wastes space or leads to storing the data for more than one application in the memory. Storing data that is used by multiple applications in one memory leads back to the problems that required the cross point switch.

A disadvantage to the use of multiple memories is evident when multiple destinations need to receive almost the same memory output, such as requiring the data time shifted, or starting a transfer at slightly different locations. This need demands that multiple memories hold the same data so it can be provided in the different forms.

A different requirement when storing data from multiple sources is the need to merge data within the memory. In image processing, for example, one source is providing data that, together with a second source of data, forms a full image. The need to merge in memory or to spatially “stitch together” two or more memory streams into a single memory image is a common requirement. Proprietary logic can be created to merge into memory, but flexibility is commonly sacrificed to achieve this result.

Collectively the aforementioned problems of memory allocation, quantization, and management have been of concern to especially pipelined system designers. The main-memory systems of conventional CPU's offer the memory capacity but not the bandwidth needed for pipelined solutions. Prior art solutions have added hardware, such as external interface multiplexers, to compensate for memory limitations, but these have provided only incremental improvement rather than a general solution.

The pipelined system designer needs a memory that can hold all the data, receives the data from a number of sources, can intersperse the data from the number of sources as needed into whole set of data, and can supply the data to a number of destinations, including providing a different “view” of the same data to different destinations.

### BRIEF SUMMARY OF THE INVENTION

In accordance with the present invention, a streaming memory unit (SMU) is disclosed that makes a single ported memory look like a multi-ported memory to a number of clients. Multiplexers and demultiplexers external to the SMU perform time-division multiplexing and demultiplexing of data to allow transfers between clients (sources or destinations of data) and sequential locations in memory. A client, like an image gathering system, may transfer data for a number of discrete sources, such as cameras, where these discrete sources are referred to as contexts. The data from the discrete source is associated with a context code to facilitate mapping the data and its source. A destination client may similarly gather data for a number of discrete destinations, each assigned a context code. The SMU incorporates a unified buffer to store context identified data being transferred between clients and the memory. A write port to the SMU receives time-division multiplexed data from clients and a read port delivers time-division multiplexed data to clients. Each of these transfers, while synchronized to the SMU, is initiated by actions by the client. A memory port between the SMU and memory allows the SMU to conduct transfers that efficiently use address inferred techniques to access sections of memory. The SMU uses shared logic elements whenever possible. Transfers to a context parameter store configure the SMU. The SMU uses the context parameters in conjunction with the shared logic to tailor the operation of the logic for each context.

Command and status vector structures allow for simultaneous initiation and monitoring of transfers for multiple contexts. The SMU manages the data transfers using the context codes, which have an agreed upon association with discrete sources and destinations. The multi-context SMU supports multiple concurrent read and write contexts.

The SMU brokers access to a memory, where one disclosed memory is an image memory. When image data comes from multiple sensors, such as cameras, the SMU can be configured so that, regardless of the configuration of sensor inputs, all data is stored in image memory as if it came from one sensor. The image memory holds all data in wide words that are used at the time-division multiplexed ports.

Contenders for write access to the memory can include, but are not limited to, sensor data through an acquisition system, an on-board processor, a host processor and a pipeline processor. Contenders for read access to the memory can include ports acquiring data for an analysis facility, the on-board processor, and the host processor.

One key to the operation of the SMU is the set of context codes. A host processor in the overall system coordinates the use of the context codes to identify different sources and destinations. Data to be written into memory through the SMU is identified by its context code. The context code determines which part of the unified buffer holds the words of data and, in conjunction with the context parameters, specify the memory addressing for that context. When a client initiates a context, the buffers are prepared to receive data and, for a READ context, data is read from memory into the appropriate part of the buffers. When the client issues a READ command, it provides a context code that the SMU interprets to find the data in the unified buffer. When the client issues a WRITE command, it provides a context code that the SMU interprets to store data into the unified buffer.

The SMU incorporates registers that control how the internal logic operates. The registers are mapped as memory locations in a processor's I/O memory space and must be loaded before the system can be utilized. Therefore, a processor configures the SMU to cooperate with the other components in the system. For instance, by being loaded with a particular set of values in the context parameters, the SMU is programmed to store the data from a particular sensor configuration correctly. Thereafter, an individual client transfers data and the SMU functions according to the parameters until a new configuration is loaded.

The SMU may be configured to transfer frames of data as are known in the image analysis industry or may be utilized to transfer indeterminate quantities of data. When frames of data are transferred, the transfer terminates based on the known number of words in a frame. When an indeterminate quantity of data is being transferred, a signal terminates the transfer when the end of the actual data occurs.

Other respects, features, and advantages of the present invention are disclosed in the detailed description that follows.

### BRIEF DESCRIPTION OF THE SEVERAL VIEWS OF THE DRAWING

The invention will be understood from the following detailed description in conjunction with the drawings, of which:

FIG. 1 is a block diagram of an idealized multiport memory;

FIG. 2 is a block diagram of an image processing system in which a memory controller coordinates access to a memory according to the invention;

FIG. 3 is a block diagram of a memory controller similar to that of FIG. 2 including a streaming memory unit (SMU);

FIG. 4 is a block diagram of an implementation of the SMU of FIG. 3;

FIG. 5a is a diagram of connections to the unified FIFOs in the SMU of of FIG. 4;

FIG. 5b is a diagram of logic in the FIFOs of FIG. 5a used to determine the work needing to be done for a context;

FIG. 5c is a diagram of the addressing logic for the FIFOs of Fig. 5a;

FIG. 6 is a diagram showing the interrelationship among a sequencer, an arbiter and an address generator in the SMU of FIG. 4;

FIG. 7 is a simplified state diagram of the sequencer of FIG. 6;

FIG. 8 is a state diagram for each context maintained by the arbiter of FIG. 6;

FIG. 9 is a block diagram of logic in the arbiter of FIG. 6 to identify a context to suggest to the sequencer of FIG. 7;

FIG. 10 is a state diagram for each context maintained by the unified address generator of FIG. 6;

FIG. 11 is a block diagram of the cycle-per-line (CPL) and line-per-frame (LPF) counters of the unified address generator of FIG. 6;

FIG. 12 is a block diagram of a core address generator of the unified address generator of FIG. 6;

FIG. 13 is a diagram depicting pool addressing applied to the core address of FIG. 12;

FIG. 14 is a block diagram of FAULT generation logic of the unified address generator of FIG. 6; and

FIG. 15 is a data flow diagram illustrating data flows at the ports of the multi-context SMU of FIG. 4.

### DETAILED DESCRIPTION OF THE INVENTION

A streaming memory unit (SMU) is herein disclosed that coordinates and arbitrates access to a single memory for multiple clients that either read or write data to a memory. The data interface between the SMU and the memory is a single n-bit wide bidirectional port. The data interface between the SMU and the clients includes a time-division multiplexed n-bit wide read port and a time-division multiplexed n-bit wide write port. The n-bit wide word is herein referred to as a “superword” and in an exemplary implementation is 64 bits wide. A multiplexing/demultiplexing structure external to the SMU melds the write data from the multiple clients into the write port and breaks apart the data stream from the read port for the multiple clients. The multiplexing/demultiplexing structure may be unified, performing the functions needed for all clients as a monolithic logic block, or factored, where levels of multiplexors and demultiplexers are concatenated to perform the functions needed. The multiplexing/demultiplexing structure is not a part of the SMU itself, but is discussed to illustrate alternative uses of the SMU structural architecture.

The SMU/memory interface function is specified for a maximum usable bandwidth that allows margin for refresh operations. For reliable operation, the total bandwidth used for data on the read and write ports cannot exceed the maximum bandwidth other than for short periods. Detail on the maximum usable bandwidth is provided below. The SMU functions with ordered data (data to be stored sequentially in memory). Registers that are set during an initialization process allow a system controller to specify parameters that control how the ordered data to/from different clients is stored in memory. The SMU uses context codes to identify unique streams of data. The architecture of the SMU is amenable to a change in the number of context codes. Architecturally, a convenient number of context codes is a power of 2, with half of the context codes assigned to read clients and half assigned to write clients. A context code and byte enable signals accompany data to be written by the SMU and a context code identifies which data the SMU should supply on the read port.

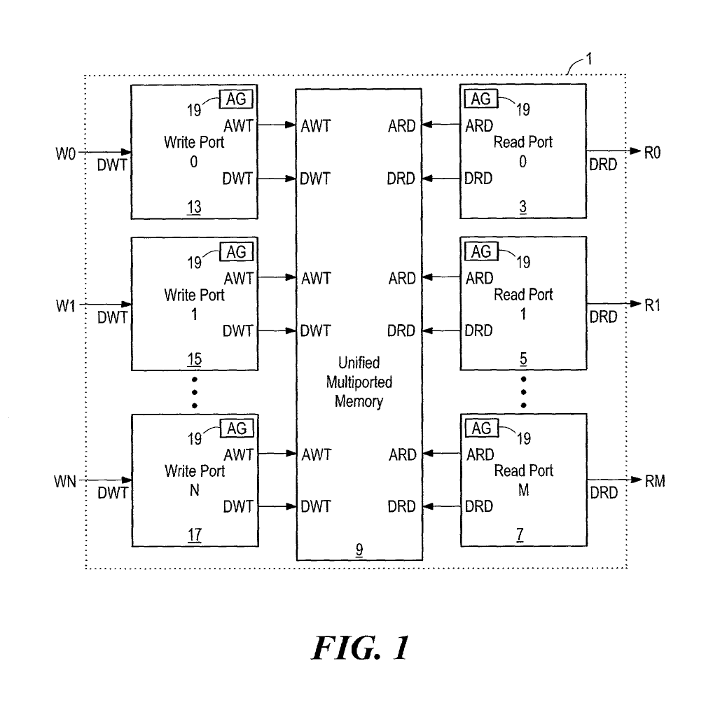

The goal of the SMU is to allow users of the memory system incorporating the SMU to operate as if the memory is configured as in FIG. 1. In FIG. 1, the memory system 1 provides M individual dedicated read ports 3, 5, 7, etc and N individual dedicated write ports 13, 15, 17, etc that access the memory 9 independently of each other. Each port 3, 5, 7, 13, 15, 17 incorporates an address generator 19 to supply read and write memory addresses A_{WT}, A_{RD}. While the data paths D_{WT}, D_{RD} between the ports and the memory 9, are all the same width, the ports may incorporate concatenation or distribution logic to allow each client to transfer data at its natural width.

As described below, the appearance of a number of independent write ports and read ports is created through the use of context codes. Thirty-two context codes are used in the implementation described, although this number of context codes can be varied. In the implementation described, half the context codes are reserved for sources (write contexts) and half are reserved for destinations (read contexts), with one read and one write context code reserved for a host processor client. Alternate embodiments assign context codes to clients, including processors, as required by the configuration implemented. The organization of the context codes of the embodiment described is not a design limitation. A configuration process for a system incorporating the SMU assigns context codes to clients based on the uniqueness of the data from the source or destination. For example, four context codes may be assigned to four write clients that store data from four cameras into image memory. Alternately, one read client that compares two sets of data stored in two regions of the image memory may be assigned two context codes. The context codes can be used throughout the system to identify the unique data sources and destinations. For instance, context codes can be used to identify a type of data from its source, through a data interface, to the SMU.

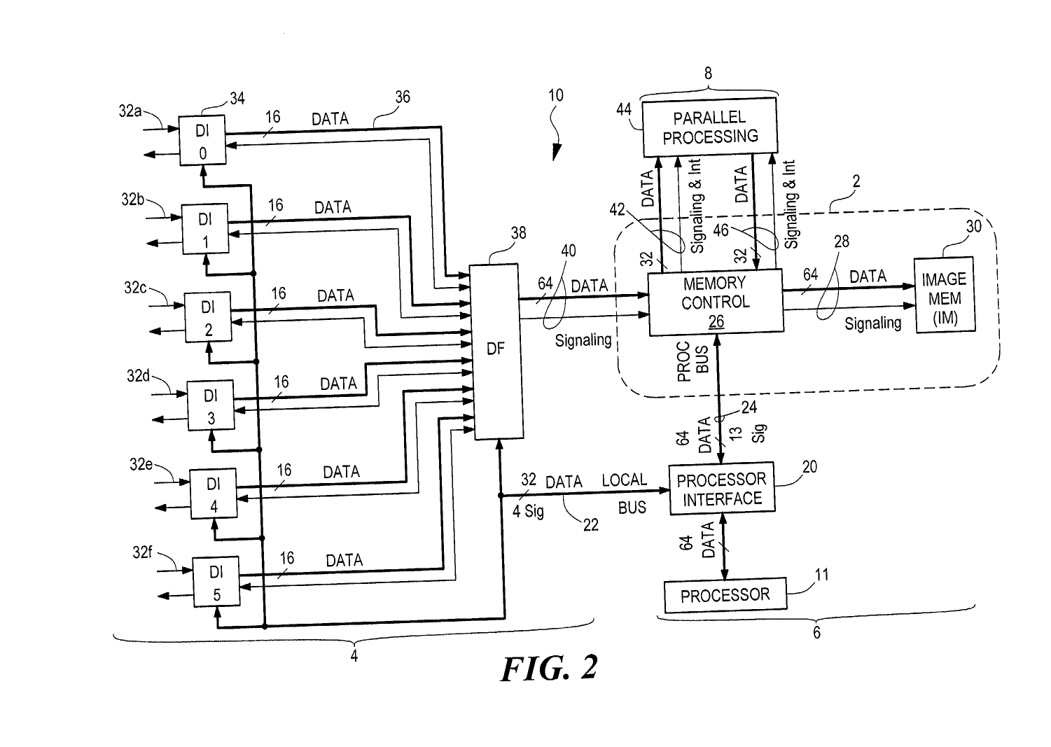

FIG. 2 illustrates a specific example of an image analysis system 10 utilizing a memory controller incorporating an SMU. Here a memory subsystem 2, incorporating an image memory 30, is surrounded by a processor section 6, a data acquisition section 4 and a parallel processing section 8. In the implementation shown in FIG. 2, data is written into image memory 30 in 8-byte superwords. Each of the sections 4, 6, and 8 may transfer data with the image memory 30 at a different rate. A memory controller 26 acts as the gateway and arbiter of access to the image memory 30.

The processor section 6 accesses the image memory 30 through a processor interface 20 utilizing a processor bus 24. The processor 11 may be an embedded processor, a host processor or some combination of processors as required. The processor 11 may control the overall operation of the image analysis system 10 and perform processing on data in the image memory 30. Data written through the processor interface 20 sets up the image processing system 10, including the memory controller 26, and loads images, such as patterns, into the image memory 30. The data that is read by the processor via the processor interface 20 may be status data used to monitor the memory subsystem 2 or may be image data for analysis.

The data acquisition section 4 uses context codes to associate data with different sources. The data acquisition section 4 receives data from cameras or other sensors (not shown) to be stored in the image memory 30. Each camera is a source of data assigned a write context code. In system 10, camera data is received serially from multiple taps 32(a-f) into data interfaces (DI) 34 where the serial data is organized into 16-bit words of data. The 16-bit data, along with byte enables and context code, is transferred to a data-multiplexing formatter (DF) 38 over connections 36. The DF 38 organizes the data from each camera into 64-bit words, still associating the data with a set of byte enables and its context code. The 64-bit words, byte enables and context codes are time-division multiplexed onto one bus 40 that transfers the 64-bit words to image memory 30 through the memory controller 26.

Parallel processors usually require large amounts of data for analysis. Parallel Processing block 44 is illustrative of the data connections needed for parallel processing. Here, at least one 32-bit read bus 42 transfers data from the memory controller 26 for use by the parallel processing block 44 and at least one 32-bit write bus 46 transfers data, such as results, to the image memory 30 through the memory control 26. During an analysis, the read bus 42 may carry context identified image data from one part of image memory 30 and context identified pattern data from another part. The write bus 46 may write results of the analysis into a number of portions of image memory 30 with each result identified by a separate context code. Alternately, a number of separate physical read and write ports may be used to transfer data for a number of contexts of data.

The memory controller 26 manages the various memory requests, uses the context codes to maintain the association between data and sources or destinations, converts disparate data widths to a consistent width for the image memory 30, and accesses the image memory 30 using efficient algorithms. While FIG. 2 illustrates one implementation of an image analysis system that utilizes the SMU to facilitate multiplexed access to a memory, many alternate embodiments are possible.

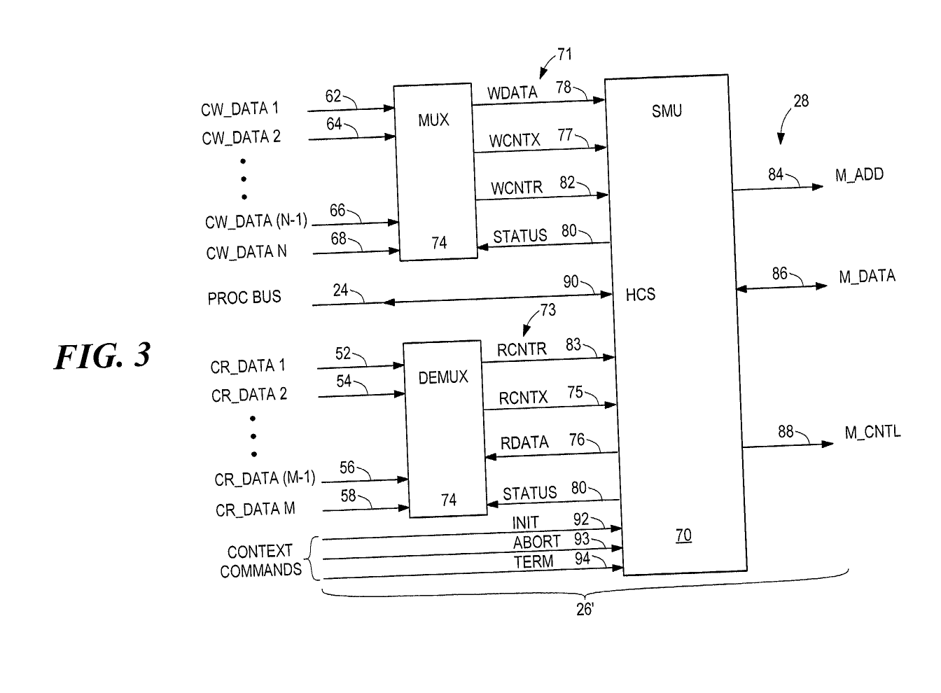

FIG. 3 further amplifies the multiplexing/demultiplexing functions of a generalized memory controller 26′, illustrating that data to be written to the image memory 30 (not shown) from the N sources is multiplexed by a multiplexer 74 before it is presented to the Streaming memory unit (SMU) 70. Further, data coming out of the SMU 70 is demultiplexed and distributed to the M destinations by a demultiplexer 72. A write port 71 between the multiplexer 74 and the SMU 70 includes data 78, context 77, and control 82 signals to the SMU 70 and status signals 80 from the SMU. A read port 73 between the demultiplexer 72 and the SMU 70 includes context 75 and control 83 signals to the SMU 70 and data 76 and status signals 80 from the SMU 70. In this implementation, the processor bus 24, representing any controlling entity such as a host CPU, interacts with the SMU 70 via a host control and status port 90 (HCS) to set up the SMU 70 for operation and to send commands to the SMU 70. In some embodiments, a number of context codes are assigned to the processor to allow data transfers between the processor and the memory.

A number of context specific commands arrive at the SMU 70 in the form of vectors where each context is assigned a bit position in the vector. A positive pulse on the appropriate vector bit will change the state of the mechanisms for the corresponding context in the SMU. In the illustrated embodiment, the vectors are carried on dedicated busses. An Initiate (INIT) bus 92 is used by a client to initiate a context. An Abort (ABORT) bus 93 is used to abort a context that has been INITed. A Terminate (TERM) bus 94 is used to signal that all transfers by the client for that context are complete. In the following description, when one of the three context specific commands is proceeded by a “C_”, it indicates a command for a Context. C_INIT implies an initiate command for context C, where C could have as many values as context codes assigned.

The multiplexer 74 of FIG. 3 multiplexes many types of data inputs. Multiplexed camera data such as that from DF 38 of FIG. 2, data from a parallel processing interface such as input 42 of FIG. 2, and data from a processor, such as the processor interface 20 of FIG. 2 are three illustrations of types of data inputs. In other applications, such data is an instantiation of 1D or 2D data streams such as; a compressed or encoded data stream to be stored sequentially in memory, data acquired from experimental apparatus, or conventional file data originating at a computer. The multiplexer 74 supplies the SMU 70 with time-division multiplexed data for up to as many sources of data as the context codes identify.

In the implementation shown, the demultiplexer 72 of FIG. 3 demultiplexes data for up to as many destinations as are defined by the context codes. This data may be destined for different types of destinations, such as for a parallel processor, for analysis by a conventional CPU, or for display. In other applications, such data is an instantiation of 1D or 2D data streams such as; a stream of data to an instrument, or a a file to a computer system. The demultiplexer 72 receives time-division multiplexed data from the SMU 70 and provides it to the destinations.

The control signals 82 in the write port 71 include a write enable for strobing in the data, and byte enables to identify which bytes in the word are to be written to memory. The control signal 83 in the read port 73 is a read enable to tell the SMU 70 to provide the data for the context specified by the RCVTX signals 75. The status signals 80 from the SMU 70 to the multiplexer 74 and demultiplexer 72 provide per-context idle or busy information on data transfers in process, as described below.

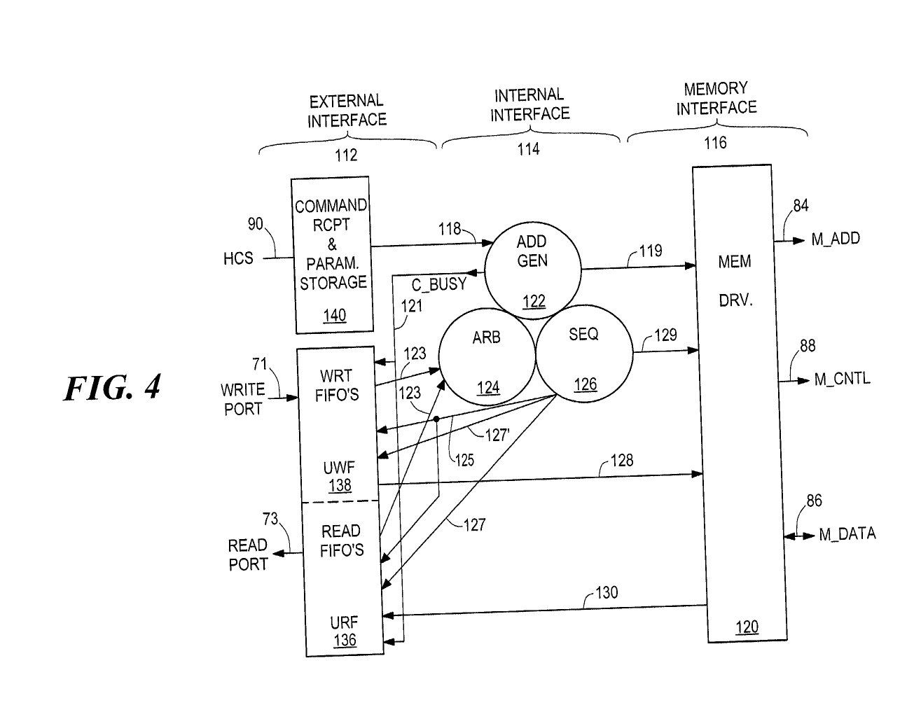

The SMU 70 presents data to the image memory 30 via an interface 28 composed of a data bus 86, an address bus 84 and control signals 88. As described below, the SMU uses a memory driver block 120 (FIG. 4) to handle the housekeeping tasks for the particular memory devices used. For instance, when image memory 30 is implemented using dynamic RAMs, the SMU 70 intersperses refresh cycles among the data accesses, and the memory driver block 120 translates the SMU 70 refresh control signals to the particular control lines needed to refresh the devices in the image memory 30. The SMU control of interface 28 is tailored for transfers of multiple words of data (streams) to be stored in sequential locations of the image memory 30. The interface 28 supports a single word transfer, but stream transfers are more efficient.

The SMU 70 is organized as shown in FIG. 4. An external interface 112 interfaces to the external components specifically those that multiplex and distribute the data such as the mux 74 and demux 72 of FIG. 3. The internal logic 114 coordinates the external interface data transfers and the image memory 30 transfers. The memory interface 116 receives address and control signals from the internal logic 114, and data signals from the external interface 112. It converts these signals into the appropriate levels and organization for the physical memory being used in the image memory 30.

The external interface 112 buffers data in a unified set of circular first-in/first-out buffers (FIFOs) 136, 138. Data that is to be written into the image memory 30 is received on the write port 71 tagged with a corresponding context code. The data and byte enables are stored in that context's portion of the write FIFO 138. Data to be read from image memory 30 is pre-fetched by the SMU 70 from the image memory 30 into the read FIFO 136 by a mechanism described below. The client requests the data by context code over the read port 73 and the data is read out of that context's portion of the read FIFO by the SMU 70. The Unified Write FIFO (UWF) 138 and Unified Read FIFO (URF) 136 are typically organized as dual-ported circular FIFO's, as are known in the industry. Therefore the data may be transferred between URF or UWF 136, 138 and image memory 30 at the same time as the read port 71 or write port 73 is accessing URF or UWF 136, 138. Logic (not shown) associated with the UWF and URF 138, 136 assures that a word being written is not being read simultaneously. Context specific FIFO status variables 123 provide inputs to the arbiter 124 that are used in arbitrating access to the memory drivers 120.

The external interface 112 also includes command reception and parameter storage logic (CRPS) 140 to receive commands and hold context parameter values. Commands received by the CRPS 140 are processed by the internal logic 114. The commands that can be sent to the CRPS 140 are described with reference to Table 1 below.

TABLE 1
Transactions between SMU and Rest of a System

| Command | Source: |
|---|---|
| Load Context Parameters | Host Processor |
| Reset the SMU | Host Processor |
| Read Statistics | Host Processor |
| Context Initiate | Client for a Context |
| Context Abort | Client for a Context |
| Context Terminate | Client for a Context |
| Context Read | Client for a Context |
| Context Write | Client for a Context |

Load Context Parameters

loads the context parameters for a context via the processor bus 24 prior to a data transfer. The context parameters, defined below for this implementation, are those parameters needed by the SMU 70 to control operations for a context's data transfer. In general, each context will operate with context parameters unique to the context. However, any number of contexts may have the same values for their context parameters, allowing simultaneous, time shifted and spatially shifted access to the same data.

Reset the SMU

The processor resets the whole SMU 70 in order to bring all logic to a known state. This reset places each component part of the SMU 70 in a known state and is usually performed at the start of usage of the SMU 70.

Read Statistics

The host processor reads statistics from the SMU 70. These statistics are primarily for diagnostic purposes.

Context Initiate

A client starts a data transfer for a context by sending a context initiate (C_INIT) command. The client only sends a C_INIT command when the context is not busy. As a response to the C_INIT, the SMU 70 sets the context BUSY (C_BUSY) bit. In an operation described more fully below, the SMU 70 starts to transfer data from the image memory 30 to the URF 136 after a C_INIT command is received from a read context. For write contexts, the SMU begins monitoring the UWF for the presence of written data that could be transferred to the image memory 30 after receiving a C_INIT commandfrom a write context.

Context Abort

A client that has sent a C_INIT command may send a context abort (C_ABORT) command to stop the transfers for that context. C_ABORT stops the transfer, but it does not clear registers or pointers as a RESET does. The SMU 70 makes the context idle after the C_ABORT.

Context Terminate

When a client has transferred the last word for a context, it sends a Context Terminate (C_TERM) to the SMU. For a write context, the SMU 70 responds by writing any data remaining in the context's portion of the UWF 138 to image memory 30. The C-TERM command is more fully described below. For a read context, the C_TERM command is only informational. The SMU 70 makes the context idle after the C_TERM.

Context Read

Each time a read client is ready to read a word of data for a context, it issues a Context Read (C_READ). In response, the SMU 70 provides a word from that context's URF 136 to the read bus 76.

Context Write

Each time a client is ready to write a word for a context to image memory, it issues a Context Write (C_WRITE). In response, SMU 70 stores the data from the write bus 77 and byte enables from the write control 82 in the context's UWF 138. The data is later written automatically by the SMU from the UWF 138 to the image memory 30.

The Load Context Parameters Command loads values into the context parameter registers 140 from the processor interface 20 over processor bus 24 via the HCS input 90. The registers are organized as memory mapped I/O registers. The context parameters are shown in Table 2 below. Each of the parameters specifies a variable concerned with addressing memory when transferring sequential words related to a context code.

For image analysis applications, it is common to regard an image as being a rectangular frame having a height and width. The width is measured in bytes of data and the height is measured in scan lines across the width. The context parameters C_CPL and C_LPF specify the number of superword memory transfers across the width (C_CPL) and number of lines of data (C_LPF) in the height of a frame. By multiplying C_CPL by C_LPF, the number of superword transfers to image memory 30 per frame for that context can be determined.

TABLE 2
Context Parameters

| Name | Description | Size | Format |
|---|---|---|---|
| C_CPL | Number of Superword | 32 | Unsigned |
| | Cycles per Line | | |
| C_LPF | Number of Lines Per Frame | 32 | Unsigned |
| C_BASE | Base Superword Memory | 32 | Unsigned |
| | Address | | |
| C_PITCH | Per-Line Address | 32 | Signed |
| | Increment | | |
| C_POOL | Pool (Pool Base/Pool | 16 + 4 | Encoded |
| | Size) | | |
| C_HFLIP | H Flip Control | 1 | Encoded |
| — | Reserved | 32 | — |
| — | Reserved | 32 | — |

C_BASE defines the starting memory address used by the address generator 122 in calculating the memory address for that context. The actual memory address is computed based on a number of parameters as detailed below.

The C_PITCH parameter is used by the address generator 122 to alter the memory addressing at the end of each line as described below. This feature is used to allow the use of different row-scan sequential patterns in writing to memory.

The C_POOL parameter is used in conjunction with the output of the address generator 122 when data is repeatedly written into a segment (pool) of memory. C_POOL contains two variables—the pool size and the pool base address. Further details on the use of this parameter are presented below.

The C_HFLIP (Horizontal Flip) parameter indicates whether addresses should be decremented rather than incremented. When HFLIP is set, an image received horizontally flipped can be unflipped as it is written into image memory 30.

A block of eight 32-bit registers is reserved for each set of context parameters. Unused bits and words of each block are reserved for future extensions of the SMU 70.

C_BUSY 121, a per-context busy indicator is the primary status indicator in the status vector 80. The SMU 70 organizes the C_BUSY bits into BUSY vectors 80 (one read, one write) assigning each context a bit position in a BUSY vector. The SMU 70 maintains a C_BUSY bit active from the context initiate command(C_INIT) until the SMU 70 has completed the data transfers for the context. The falling edge of C_BUSY can be used to trigger a context completion interrupt to a processor.

FIG. 4 illustrates how the internal logic 114 is divided into arbitration logic 124, address generation logic 122, and a sequencer 126. The arbitration logic (ARB) 124 functions to assure image memory access to all active contexts by an algorithm that satisfies three prioritized rules:

1. Never Fail to transfer all of the right data between the image memory and UWF/URF;

2. Maximize the bandwidth of data transfers; and

3. Constrain latency.

ARB 124 may be implemented in many ways such as a round robin selection among URF/UWFs 136 and 138, or a priority scheme based on a buffer level reaching a fullness threshold. A best effort method described below uses status variables 123 from the URF/UWF 136 and 138 and satisfies the three criteria.

The unified address generation logic (UAG) 122 tracks which contexts are busy and computes the addresses for data transfers. UAG 122 uses the context parameters via line 118 in this operation. After a client initiates a context, UAG 122 uses a unified active address generator core described below to address the context's section of image memory 30, and uses a look-aside store described below to track the context specific working state of the memory address.

The sequencer (SEQ) 126 controls the timing within a memory cycle, addresses and enables data transfers over lines 125, 127 between the image memory 30 and the URF/UWF 136 and 138 and generates control signals 129 such as clocks (not shown) that are needed to control the image memory 30.

Table 3 illustrates the typical actions of a client during a transfer of data for one context and the response of the SMU 70 to each action.

TABLE 3
Steps in a Data transfer

| Client Context | | |
|---|---|---|
| sequence | SMU Action | |
| A. | Stops work for that Context if | |
| Stop any transfers | active, else no effect | |
| happening by sending a | | |
| C_ABORT | | |
| B. | No effect | |
| Prepare for transfer | | |
| by loading the Context | | |
| Parameters | | |
| C. | Places that Context in an ARMED | |
| Initialize the Context | state, starts considering the | |
| specific memory | Context for Memory Time. Status | |
| transfer mechanisms by | C_BUSY indicates Busy | |
| sending C_INIT | | |
| D. | READ- | WRITE- |
| Wait a predetermined | Context granted | No Action |
| Time | memory time, | |
| | SMU starts | |
| | filling the | |
| | C_URF | |
| E. | Context granted | Context granted |
| Transfer Data until | memory time | memory time |
| done | sufficient to | sufficient to |
| | keep C_URF full | write data from |
| | enough to be | C_UWF to memory |
| | read | so there is |
| | | buffer space for |
| | | the client |
| | | context to write |
| | | data |
| F. | Confirm idle, | Data remaining in |
| Send Terminate Command | Status C_BUSY | C_UWF written to |
| C_TERM | indicates idle | memory. Status |
| | | C_BUSY set to |
| | | indicate idle |

Before line A, the SMU is doing work for all active contexts as needed.

At Line A, the client issues a C_ABORT command to stop all actions on behalf of the context. In response, the SMU 70 takes this context to an idle status. The context status line C_BUSY indicates this idle status. The C_ABORT command has no effect on any other context.

At Line B, the client issues a series of Load Context Parameter commands. This context remains at an idle status and these commands have no effect on any other context. At Line C, the client issues a C_INIT command to start the data transfer process. The SMU 70 takes this context to a busy status. The context status line C_BUSY indicates the busy status. Internally, the SMU 70 regards this context as ARMED, a transition state between idle and OPERATING. The significance of the ARMED state is described below.

At Line D, the client waits a predetermined time, which is set by a mechanism detailed below, large enough to assure that data will have been written into a read FIFO by the end of that time. For a read context, sometime during the predetermined time the SMU 70 brings this BUSY context into scope, i.e. makes this context active and transfers data between the image memory 30 and the C_URF. For a write context, the SMU 70 does nothing for this context during this time, as there is no data in the UWF to be written to the image memory 30.

At Line E, the client starts and continues to transfer data with the SMU 70 at a pace determined by the client. For a read context, the SMU 70 brings the context into scope sufficiently often, as described below, to keep the C_URF supplied with data throughout this whole time period. For a write context, the SMU brings the context into scope sufficiently often to maintain space in the C_UWF for the client to write into.

At Line F. the client issues a C_TERM command to signal the end of the transfer. For a read context, the C_TERM command causes the SMU 70 to change the state of the C_BUSY status line to indicate idle status if some other condition has not already idled the context. For a write context, the C_TERM command causes the SMU 70 to assure that the CUWF is completely emptied. Once C_UWF is emptied, the SMU sets C_BUSY to idle.

The predetermined time that a client waits during Line D is calculated for an application by computing the maximum latency that a C_INIT instruction could encounter. This maximum latency is computed as the memory access time times the total number of buffer locations that might need service for all contexts. Although, the actual latency is likely to be smaller than the maximum latency, this time period assures that data will be available in the FIFO unless the system bandwidth is oversubscribed. Alternate implementations could make a currently internal status variable available to the clients for testing to shorten the latency period.

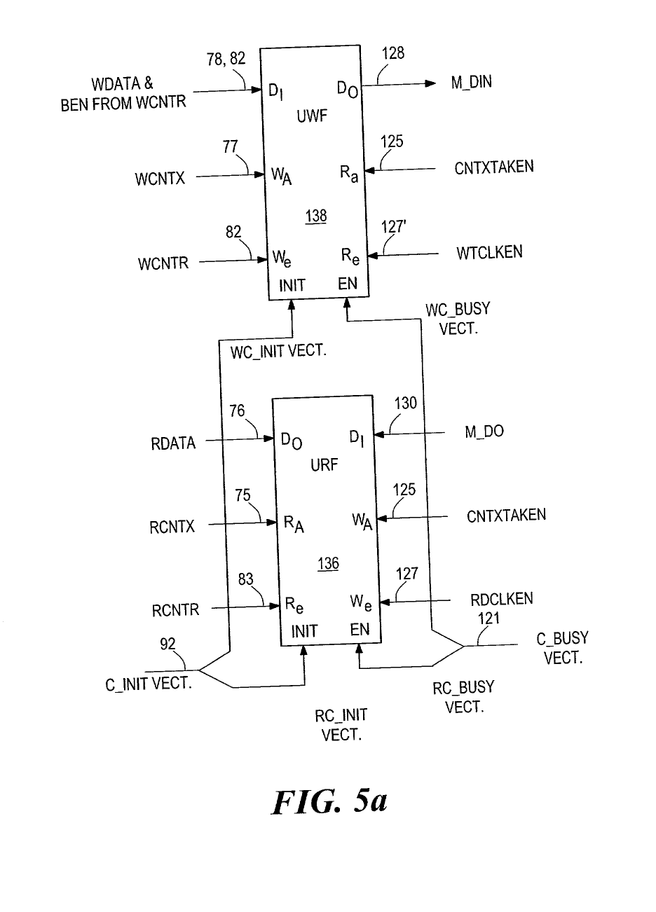

As illustrated by the sequence above, the Unified Read and Write FIFOs 136, 138 are integral to the transfer of data within the SMU. FIG. 5 illustrates details of the Unified Read FIFO 136 and Unified Write FIFO 138. FIG. 5a illustrates the connections to the Unified FIFOs. Each unified FIFO has connections identified as a Data Input Di, a Write Address Wa, a Write Enable We, a Data Out Do, a Read Address Ra and a Read Enable Re. Individual sections of the unified FIFO are initialized and enabled by connecting the appropriate bit of the INIT vector to an INIT input and the appropriate bit of the BUSY vector to an EN input. When used as a read buffer, the read port is connected to the Data Out side of the unified FIFO and the memory port is connected to the Data In side of the unified FIFO. When used as a write buffer, the memory port is connected to the Data Out side of the unified FIFO and the write port is connected to the Data In side of the unified FIFO. Table 4 summarizes this mirror-image relationship in connecting the unified FIFO.

TABLE 4
URF and UWF connections to Unified FIFO

| Unified FIFO | | |
|---|---|---|
| connection | URF Utilization | UWF Utilization |
| Data In - Di | Memory Read Port | SMU Write port |
| Write Address | CNTXTAKEN | WCNTX |
| (HOB) - Wa | | |
| Write EN - We | Mem WE | Write Port EN |
| Data Out - Do | SMU Read Port | Memory Write Port |
| Read Address | RCNTX | CNTXTAKEN |
| (HOB) - Ra | | |
| Read EN - Re | Read Port EN | MEM RE |
| Initialize - INIT | C_INIT Vector | C_INIT Vector |
| | Read Half | Write Half |
| Enable - EN | C_BUSY Vector | C-Busy Vector |
| | Read half | Write Half |

To illustrate for the UWF 138, since the UWF 138 stores byte enables as well as data in the FIFO, the data input lines D_{I} are sourced from the write port 71 using the WDATA lines 78 and the byte enable (BEN) signals in the WCNTR portion 82. The high-order-bits of the address lines W_{A}, selecting a section of the unified FIFO being used, are sourced by the write context (WCNTX) signals 77; while the low-order-bits, selecting a word in the section, are generated by logic as described below. The write enable line W_{E} is sourced by an enable signal in the WCNTR portion 82 of the write port 71. The write portion of the C_INIT vector 92 and the write portion of the BUSY vector 80 are connected to context specific portions of the UWF 138 as detailed in FIG. 5b.

The data and byte enables previoulsy stored in the UWF 138 are read out to the memory M_DIN signals 128. Logic in the memory drivers 120 (FIG. 4) separates the byte enables from the data and uses the byte enables during the memory write operation. A context code appearing on a context taken bus 125 from SEQ 126 is used for the high-order-bits of the read address signals, selecting the section of the UWF 138, and the low order bits are sourced as described below. A read enable (RDCLKEN) 127 is supplied by SEQ 126.

Associated with the FIFO for each context is logic to track the remaining capacity of the FIFO. FIG. 5b illustrates this logic for one context of the UWF 138. Where differences exist for a URF, they are noted in brackets []. Write and read counter/pointers 152 and 154 are D-bit counters (where D is related to the depth of the FIFOS) . Write counter/pointer (WCP) 152 tracks how many words have been written by the write client [by the memory 30] into the C_UWF, modulo D. Read counter/pointer (RCP) 154 tracks how many words have been read by the memory 30 [by the read client] from the C_UWF, modulo D. Difference calculator 164 determines the difference between the values of the counter/pointers 152 and 154 which is a measure of the work that needs to be done by the SMU 70. The C_POS output 168 reflects the value of the difference. Block 166 passes the C_POS signals on for write contexts [performs a 1's complement of C_POS] and the output is named C_WORK 167 indicating how many superwords need to be written to [need to be read from] memory for this context.

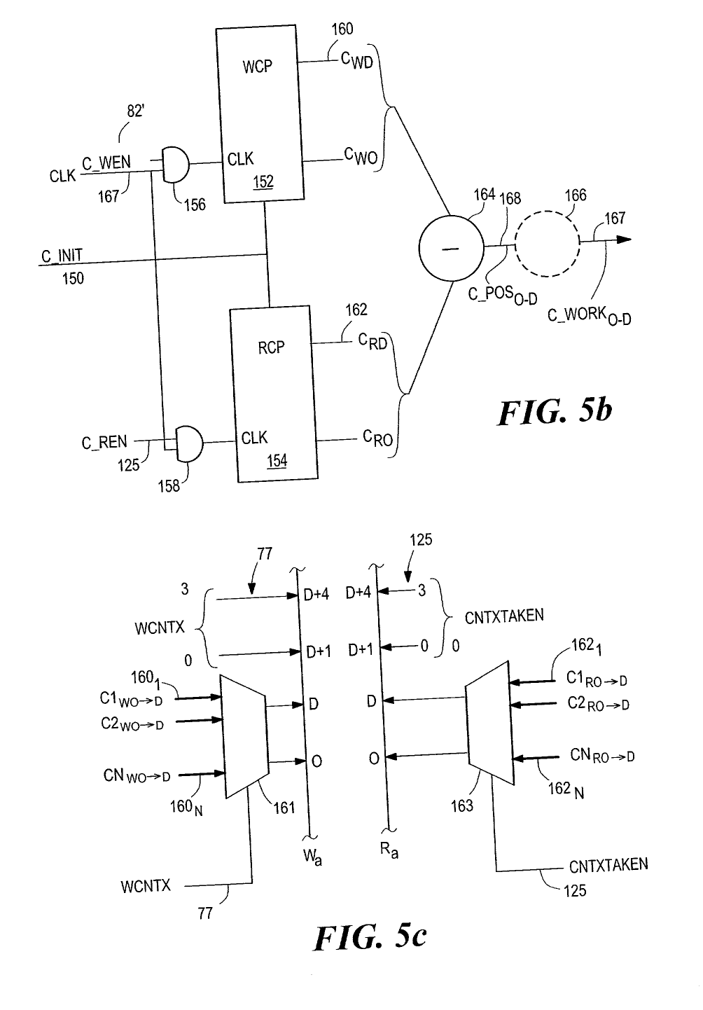

The low-order address bits for the unified FIFOs 136, 138 are formed from the counter/pointer outputs. This logic is illustrated relative to the UWF 138, as shown in FIG. 5c. All of the write counter outputs C_{WO}-C_{WD} 160 for each write context 1-N, are input to a multiplexer 161 that uses the write context code WCNTX 77 to select which bits pass through the MUX 161 to the low order write address bits Wa. All of the read counter outputs C_{RO} - C_{RD} 162 for each write context, 1-N, are input to a multiplexer 163 that uses the write context code CNTXTAKEN 125 (FIG. 6) to select which bits pass through the MUX 163 to the low order read address bits Ra. The multiplexers 161, 163 may be implemented in a number of ways as is known in the art. By these mechanisms, unified circular buffer addressing is implemented for data being written to the UWF 138 by a client and data being read from the UWF 138 for writing to image memory 30.

FIG. 6 illustrates the interfaces among the Unified Address Generator (UAG) 122, the Arbiter (ARB) 124 and the Sequencer (SEQ) 126 of FIG. 4. The SEQ 126 is concerned with providing the correct control signals to the URF 136/UWF 138 and image memory 30. The ARB 124 is concerned with determining the best next-action for the internal logic 114. The UAG 122 is concerned with producing the correct address signals for the memory cycles. UAG 122 is also concerned with stopping the current memory transfer for a number of reasons detailed below.

The UAG 122 and ARB 124 receive the C_INIT vector 92 to initiate the contexts, as is detailed below, and they also receive the C_TERM Vector 94, which is used to stop operations on the contexts. The UAG 122 sets context busy flags 121, that are incorporated in the C_BUSY vector 80, for contexts that have been initiated. ARB 124 uses the context busy flags 282 and the context work values 167 from the URF and UWF 136, 138 to continually generate an instruction asked (IASK) signal 281 and a context asked value 282.

SEQ 126 samples and acts on the IASK 281 and context asked 282 values when in an idle state. When SEQ 126 is transferring data to memory, signals CONTEXTTAKEN 286, RUN 285, CVAL 287, and one of RDCLKEN 296 or WTCLKEN 297 are activated as needed to coordinate with the UAG 122 and FIFOs 136, 138. In addition, memory control signals 290 are sent to the memory 30 to perform the transfer(s). The SEQ 126 send a REFFILL signal 291 to ARB 124 each time a refresh cycle is performed so ARB 124 can track memory refreshes, as detailed below. UAG 122 receives the CONTEXTTAKEN 286, RUN 285, and CVAL 287 signals and uses them to generate the memory address 119. A Fault signal 288 from UAG 122 stops the current operation of the SEQ 126 and returns it to the idle state. The fault logic is described below in conjunction with the address generator 122.

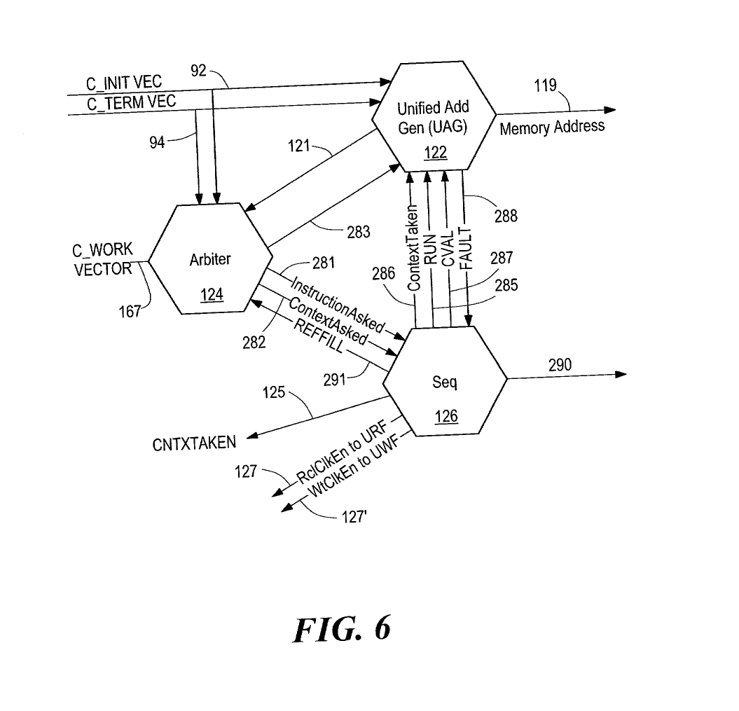

FIG. 7 is a state diagram of the operation of the Sequencer 126. While the operation of SEQ 126 is described utilizing dynamic RAM elements, it will be appreciated that static RAM simplifies SEQ 126. SEQ 126 is either in an IDLE state 380, Refresh state 395, or Context Valid state 390. IDLE 380 is the state the SEQ 126 returns to when an operation is completed. While SEQ 126 is in IDLE state 380, it samples the IASK signals 281 from ARB 124. The IASK signals 281 indicate one of four instructions: Idle, Refresh, Write or Read. For an Idle instruction, SEQ 126 remains in IDLE state 380 as shown by loop 381. For a Refresh (REF) instruction, SEQ 126 executes one pass through the REF loop 382, performing a set of refresh steps 396 . . . 398 as are needed to accomplish one row refresh cycle, as known in the art. At the completion of the single cycle, the REFFILL 291 signal is sent to ARB 124 and SEQ 126 returns to the IDLE state.

For a write (WT) instruction, SEQ 126 enters the Context Valid State 390, raising the CVAL signal 287 while in that state. During the Activate Write state 385, SEQ 126 samples the ContextAsked signals 282 and passes them on as ContextTaken signals 286 to the UAG and FIFOs. The next clock cycle moves the state machine to the RUN Write State 386 during which the RUN signal 285 is asserted, this marks the start of the context “being in scope”. During the RUN Write State 386, SEQ 126 drives the WtClkEn signal 127′ to the UWF 138, and the signals to control memory 290 with every clock tick (not shown). While in the RUN Write State 386, SEQ 126 tests the FAULT signal 288 from the UAG 122. If FAULT 288 is active, the next clock tick moves the state machine to the Deactive Write State 387 causing the RUN signal 285 to become deasserted, this mark the end of the context “being in scope”. At the next clock tick, the state machine exits the Context Valid State 390 and returns to the IDLE State 380.

The Sequence of states 391, 392, 393 for a Read (RD) operation 384 parallels the states for the WT operation 383 but causes different control signals to be sent to the URF 136 and memory 30.

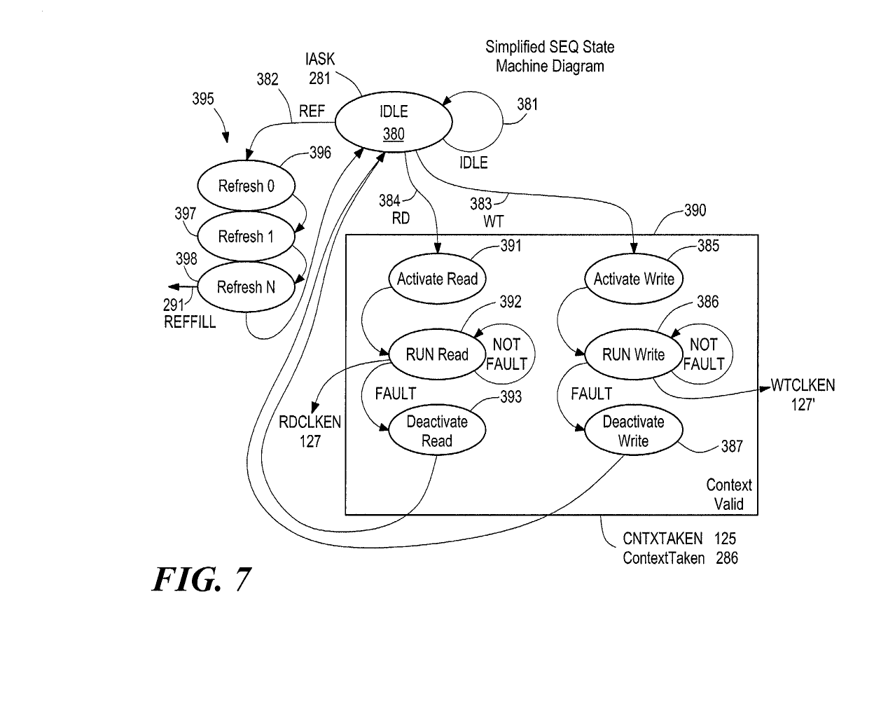

The arbiter (ARB) 124 monitors the work needed indicator from each context and a refresh gauge in order to determine what work has priority. FIG. 8 shows the state transitions for each context. As a result of a RESET or C_INIT command, the context is placed in the C_IDLE state 350. A write context is simultaneously placed in a C_NOT_FLUSHING state 354. When equation A (below) is satisfied, the context transitions to the C_ACTIVE state 352. The C_ACTIVE state 352 indicates that the context has work to be performed. For a write context, the context has work to be done when there are words to be written to memory stored in the UWF 138. During normal operation, when the context is not flushing, the context enters the C_ACTIVE state 352 when the number of words to be transferred is greater than a base threshold determined by the pipelined write structure used. The base threshold is set so there are enough words to be transferred to avoid a structural hazard error, as is known in the art. During flushing, any number of words in UWF will cause the transition to C_ACTIVE state 352. and exception logic (not shown) as is known in the art, prevents erroneous writes to memory.

A = WRITE{[C_BUSY ● C_NOT_FLUSHING ● (C_WORK ≧
C_BASE_THRESHOLD)]
or
[C_FLUSHING ● (C_POS ≠ 0)]}
or
READ[C_BUSY ● (C_WORK ≦ C_CEILING_THRESHOLD)]

For a read context, the context has work to be done when there is space to write words into the URF 136. To accommodate the pipelined read structure, the number of spaces to be filled must be less than a ceiling threshold.

A context in the C_ACTIVE state 352 is considered for being brought into scope as described below. When equation B (below) is satisfied, the context transitions to the C_IDLE state 352 again. For a write context that is not flushing, this transition occurs when the number of words needing to be transferred from the C_UWF falls below the base threshold. For a read context, this transition occurs when the number of words held by the C_URF exceeds the ceiling threshold.

B = WRITE{[C_BUSY ● C_NOT_FLUSHING ● (C_WORK ≦
C_BASE_THRESHOLD)]
or
READ[C_BUSY ● (C_WORK ≧ C_CEILING_THRESHOLD)]

Examination of equations A and B reveals that write contexts go in and out of C_ACTIVE 352 based on the relationship of C_WORK and the C_BASE_THRESHOLD, and read contexts go in and out of C_ACTIVE 352 based on the relationship of C_WORK and C_CEILING_THRESHOLD.

With respect to the write-specific states 354, 356, a write context is usually in the C_NOT_FLUSHING state 354. When equation C (below) is satisfied, the context enters the C_FLUSHING state 356. In essence, a C_TERM command while the context is still BUSY causes the change to the C_FLUSHING state 356.

C=C_BUSY·C_TERM

A context returns to the C_NOT_FLUSHING state 354 least when the C_BUSY bit falls (Equation D).

D=C_BUSYfallingedge

Each ARB context state machine has one output C_Active 358 that is used in generating the CONTEXTASKED signal 282, 125 as described below.

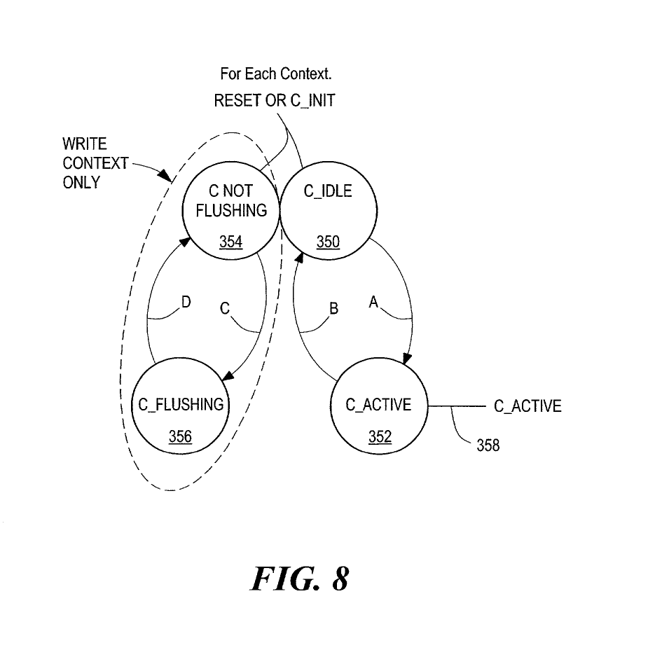

The logic in ARB 124 that determines which context is to be brought into scope is shown in FIG. 9. Each context's work needed (C_WORK) is ANDed with its C_ACTIVE state by AND logic 360. This yields a dynamically changing value for ACTIVE contexts and a zero value for IDLE contexts. Maximum logic 362 examines all the values and determines the context having the maximum value, this context is identified on lines 364 and the value for this context (which may be 0) is identified on lines 363. The outputs of the Maximum logic 362 and a refresh gauge (discussed below) are used to determine the Instruction Asked.

To refresh memory 30, n row-refresh cycles need to be done every y ms (where n and y are technology dependent). ARB 124 maintains a refresh gauge (not shown) that is full when the memory is completely refreshed and that decrements every y/n milliseconds. The refresh gauge is incremented each time a row-refresh cycle is done. The refresh gauge outputs a status indicator FILL (not shown) to indicate when at least one row-refresh cycle is needed.

Best effort arbitration determines the instruction asked signal (IASK) sent to the SEQ 126 using the following rules.

1. If Max Value 363 is non-zero, the CONTEXTASKED signals 282 are generated from MAX-CONTEXT 364 and the IASK signals 281 are set to RD or WT depending on the context type.

2. If MaxValue 363 is zero, and FILL is asserted, the IASK signal 282 is set to REF.

3. Otherwise, the IASK signal is set to IDLE.

This arbitration gives context data transfers priority over refreshes, but asks for a row-refresh each time one is needed and data doesn't need to be transferred. Sufficient refresh cycles are assured by the specification of usable bandwidth. The best effort arbitration continually evaluates IASK and CONTEXTASKED, so when SEQ 126 is ready to sample these outputs they are the most current evaluations.

The ARB 124 also monitors the C_WORK values to determine whether any read or write FIFO is about to underflow or overflow because a memory transfer is transferring too many words. ARB 124 generates an ARB_FAULT 283 if either condition is detected. The ARB 124 uses a set of per-context thresholds—C_NEARLY_EMPTY (smaller than C_BASE_THRESHOLD) and C_NEARLY_FULL (larger than C_CEILING_THRESHOLD) to make the determination. The LOGICAL equations for ARBFAULT are:

CW_ARBFAULT=[ACTIVE·NOT_FLUSHING·(C_POS≦C_NEARLY_EMPTY)]

CR_ARBFAULT=[ACTIVE·(C_POS≧C_NEARLY_FULL]

ARBFAULT=[CW_ARBFAULT+CR_ARBFAULT].

Therefore, if a write context FIFO is falling below the nearly empty threshold or if a read context is exceeding the nearly full threshold, the ARB 124 will send an ARBFAULT signal 283 to the UAG to stop the transfer in progress. Note that a Flushing write context will not cause an ARBFAULT to be generated.

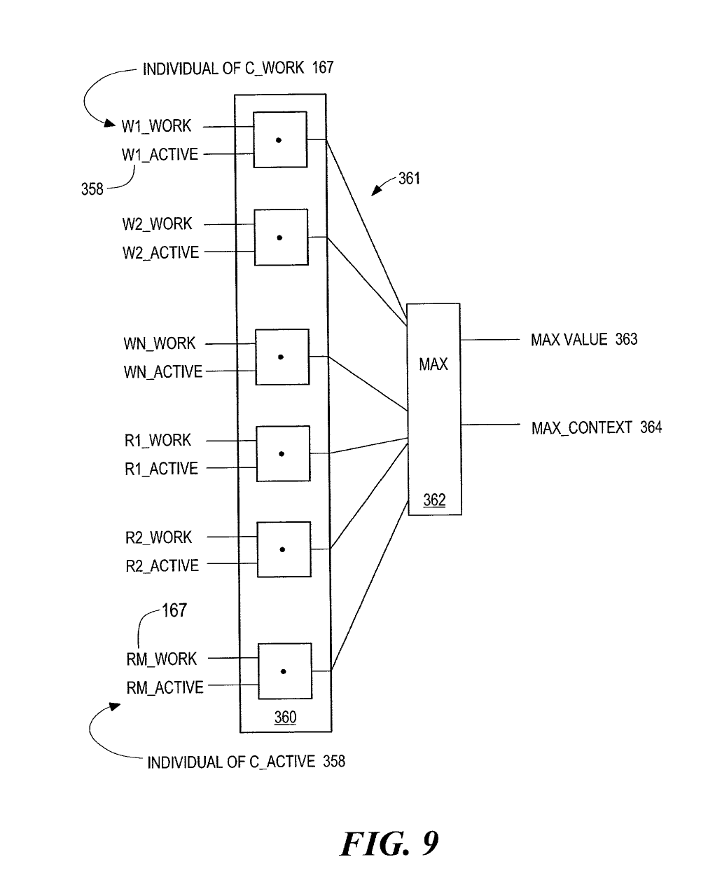

FIG. 10 shows the per-context status information maintained by the unified address generator (UAG) 122. The UAG 122 is concerned with starting up contexts, providing the addressing needed for memory access and asserting the Fault signal 288 that stops the sequencer 126.

Each context starts in the C_IDLE state 380 after a Reset command. When a C_INIT command 92 is executed for a context, the context transitions to a C_ARMED 382 state. Since the C_INIT command vector 92 allows multiple clients to change the state of their INIT bit in the command word simultaneously, the UAG 122 is adapted for simultaneous ARMing of a number of contexts. The UAG 122 asserts a C_BUSY status bit when a context enters the C_ARMED state 382. The C_ARMED state 382 allows multiple contexts to initiate operations simultaneously although only one of those context can access memory at one time. Because C_BUSY is asserted while the context is in the C_ARMED state 382, ARB 124 can select the ARMED context for ContextAsked 282 and SEQ 126 can bring the context into scope. The first time SEQ 126 brings a context into scope, as indicated by the ContextTaken signal 286 equaling the context code while the CVAl signal is asserted, UAG 124 transitions to the C_OPERATING state 384. The context remains in the C_{‘3} OPERATING state 384 until its frame completes the data transfer successfully (described below), or a Reset command is received or a C_ABORT command is received. The C_BUSY indicator remains asserted while the context is in the C_OPERATING state 384.

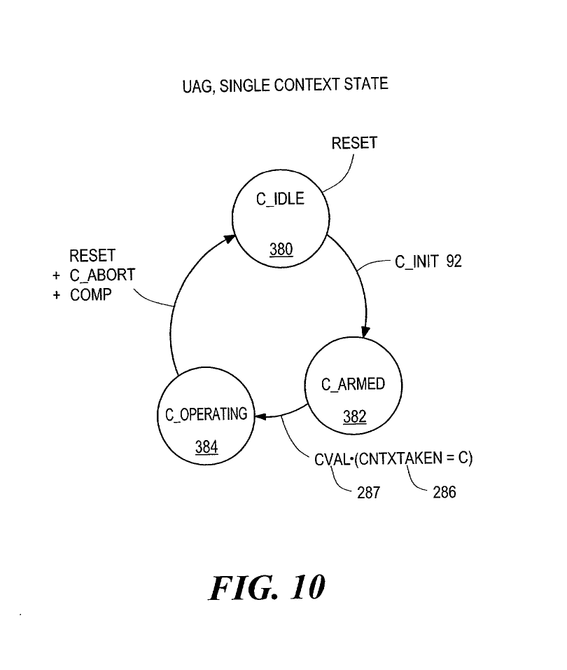

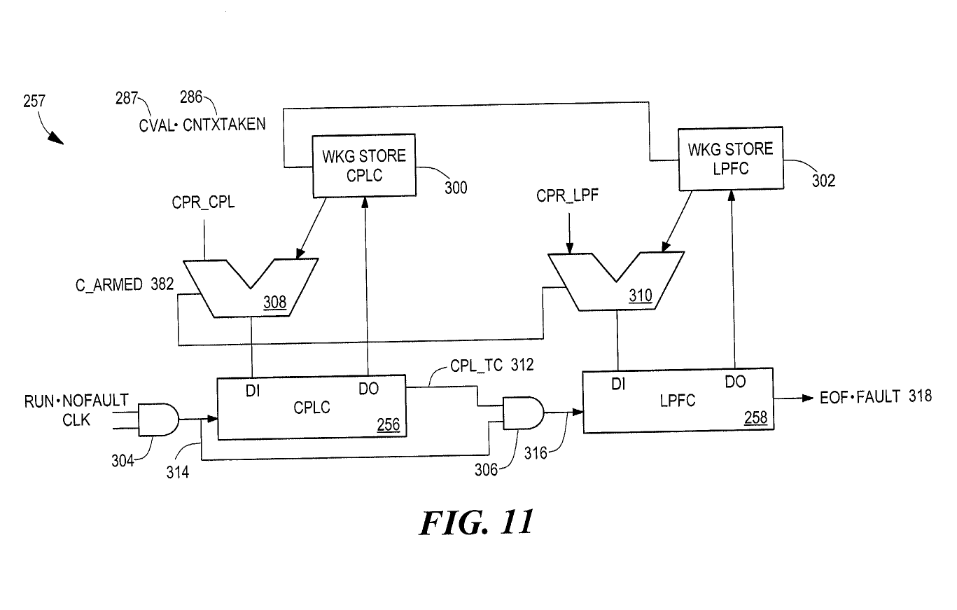

The address generation part of the UAG 122 is composed of context switching part followed by a post context part. The context switching part consists of a cycles per frame unit (CPFU) 257, shown in FIG. 11, and an address generator core (AGC) 351, shown in FIG. 12. The CPFU 257 counts the memory transfers in a frame for an in-scope context and generates an end-of-frame fault to stop transfers for the context. The CPFU 257 consists of two counters 256, 258, a set of working stores 300, 302 that function as look-aside memories for the counters 256, 258, clocking logic 304, 306 and multiplexers 308, 310 that choose the sources of the values loaded into the counters 256, 258 each time a context comes into scope. The working stores 300, 302 are sets of memory that are addressed by the current CNTXTAKEN and have the value of the element they are working for written into them each cycle. Hence, the CPL working store 300 continually has the most current value of CPLC 256 for the current context written into a memory location for that context. The two counters, cycles per line counter (CPLC) 256 and lines per frame counter (LPFC) 258, are loaded for a context when the context is brought into scope. If the context is in the C_ARMED state 382, this is the first time this context is transferring and the counters 256, 258 are loaded from the context's context parameter registers. If the context is in the C_OPERATING state 384, the CPLC 256 and LPFC 258 are loaded from their working stores 300 and 302. Each time CPLC 256 reaches a terminal count and asserts CPLCT 312, the CPLC is reloaded from the context's context parameter registers. The CPLC 256 is incremented for every clock tick on line 314 which occurs whenever RUN is active and there is no fault, that is, for each time a memory transfer takes place. The LPFC 258 is incremented for each clock tick on line 316 which occurs whenever CPLC 256 has reached a terminal count, asserting CPLCT 312, that is, once per line of memory accesses. When LPFC 258 reaches a terminal count, an end-of-frame (EOF) fault 318 is generated indicating that a complete frame of data has been transferred.

Referring to FIG. 12, the AG Core 351 executes algorithms to compute an address that can be written as:

ADD=BASE+X+(Y*PITCH).

The algorithmic component of AG Core 351 is shared among the active contexts. Therefore, since the AG Core 351 is always acting for some context, the instantaneous definition of the output of AG CORE is:

C_ADD=C_BASE+C_X+(C_Y*C_PITCH*C_CPL) .

Where:

C_ADD=The address generated for the context in scope;

C_BASE=The value of BASE in the context parameter register;

C_X=The value of a first counter for the context in scope;

C_Y=The value of a second counter for the context in scope;

C_PITCH=The value of PITCH in the context parameter register; and

C_CPL=The value of CPL in the context parameter register.

As shown in FIG. 12, the X and Y counters 350, 352, like the CPLC 256 and LPFC 258 counters, have look-aside stores 354, 356 associated with them to save the values of the X and Y counters 350, 352 while the context is out of scope. The X and Y counters 350 352 are zeroed out the first time the context is brought into scope (context is in the C_ARMED state). The X and Y counters 350 352 are loaded from the look-aside store each subsequent time the context is brought into scope. The X counter 350 increments in sync with CPLC 256 and the Y counter increments in sync with LPFC 258 for the context in scope, and their values 364, 366 are continually stored in the look aside stores 354, 356 by context. A multiplier 358 multiplies the Y output 366 by the values of C_PITCH and C_CPL from the context parameter registers. The X counter output 364, the multiplier output 368, and the C_BASE parameter from the context parameter registers are added by an adder 360 to form the core address 362.

The AG Core 351 and CPF Unit 257 provide a unified mechanism to address and track memory accesses for a number of contexts without extensive multiplexing and allow switching between contexts with little overhead.

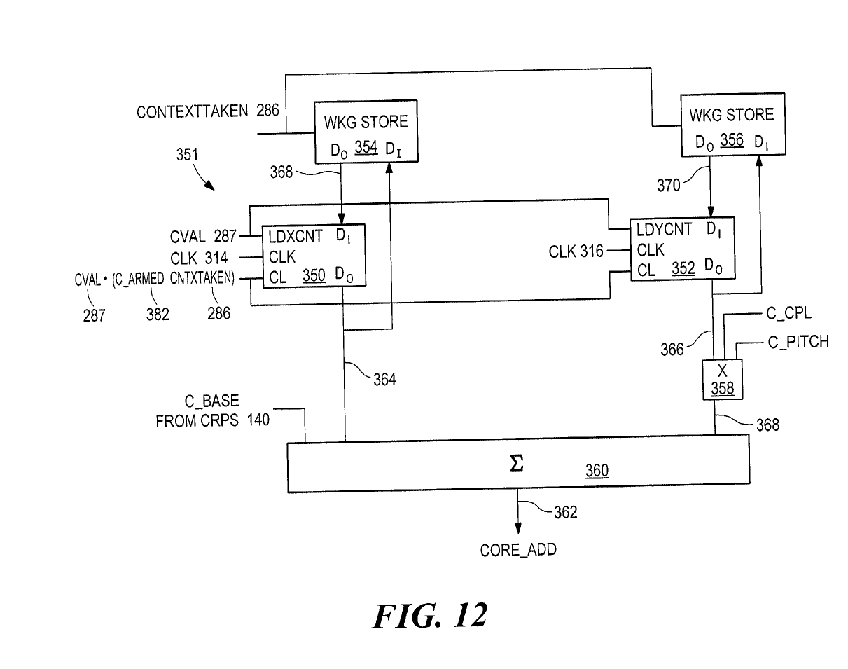

The AG Core output 362 is continually processed by post-context switching algorithms and then by algorithms that adapt the resultant addresses to the lines required by the physical memory units being used. One post-context algorithm is the pool algorithm illustrated in FIG. 13.

The pool algorithm is used when a context's transfers are limited to one area of image memory 30 organized as an endless loop. If the C_POOL context parameter is set to zero for a context, the pool feature is not used. If the C_POOL context parameter is non-zero, it is interpreted as a pool size and a pool base address. The pool size ranges from 2¹⁶ to 2³¹ superwords. A pool size mask 480 allows the appropriate number of low-order bits of the Core Address 362 to pass through gate 484 forming a Masked address 486. The value of the pool base address 494 is substituted for the masked-off high order bits by OR gate 490 to form the generated address 492. In the generated address, the low-order bits increment as dictated by the core address 362, while the high-order bits remain locked at the value of the pool base address 494. The generated address 492 is processed by logic block 494 where it is broken into row and column addressing as required by the memory devices used in the memory 30.

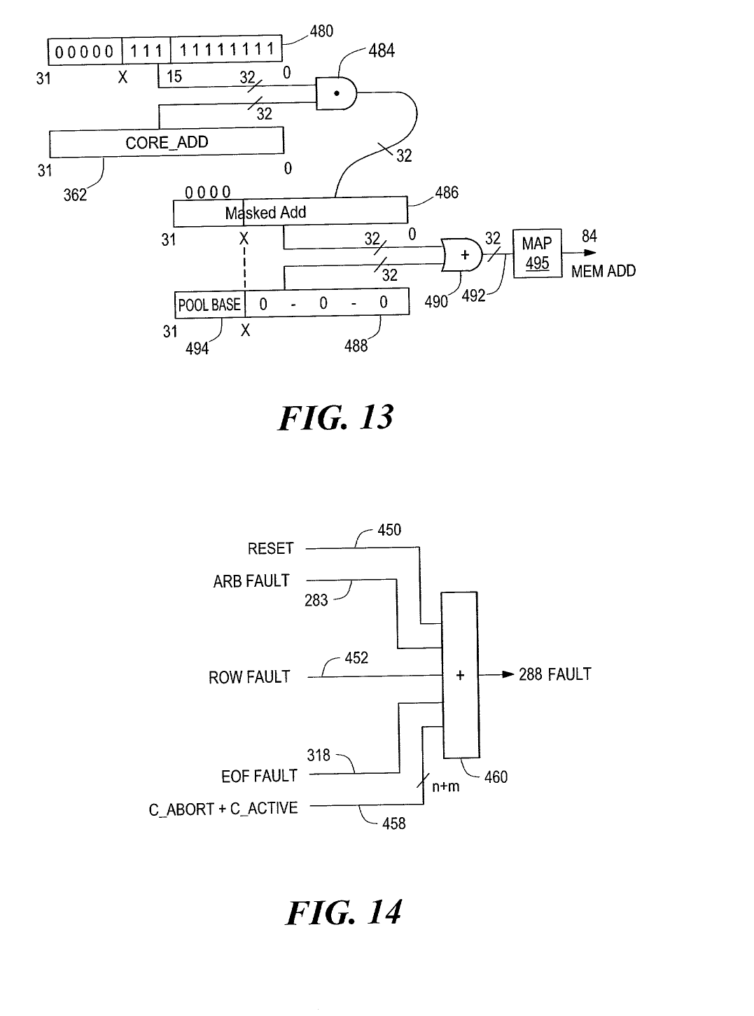

UAG 122 is responsible for generating the FAULT that stops the current operation of SEQ 126 bringing SEQ 126 back to IDLE to bring a new active context into scope. FAULT will be generated in response to at least one of the following conditions as illustrated in FIG. 14. RESET generates FAULT 288 regardless of the context in scope. When ARBFAULT 283 from the ARB 124, is asserted to stop the current context in scope, it indicates that the SEQ is about to overrun the data in the FIFOs. The UAG 122 converts the generated memory address 492 to row and column addressing using map logic 494 and has logic (not shown) that monitors the row addresses and generates a ROW FAULT 452 if a different row is about to be addressed. The End-of-Frame (EOF) fault 318, generated by the CPF unit 275, stops transfers at the end of a frame. The condition that is the OR of (C_ABORT·C_ACTIVE) for all contexts stops a transfer in progress. The OR logic 460 generates the FAULT 288 sent to the SEQ 126.

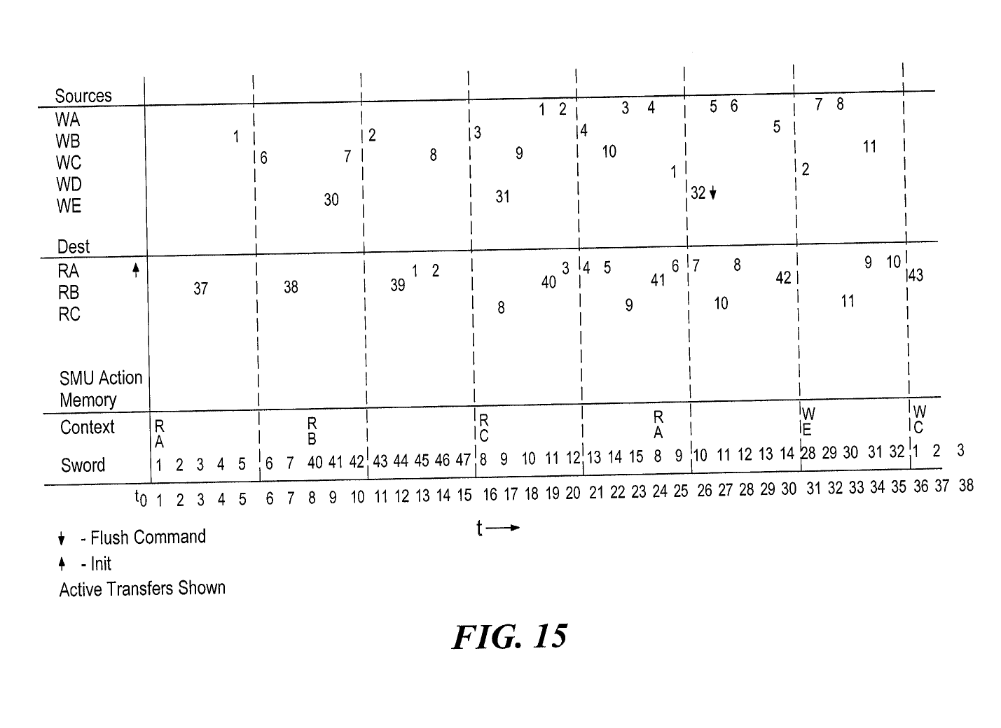

FIG. 15 is a time sequence of the inputs and outputs of the SMU 70 for a hypothetical set of sources and destinations. It illustrates the SMU 70 receiving interspersed write words and organizing them so that the transfers to image memory 30 are in bursts. The SMU 70 also reads from image memory 30 to the read FIFOs 136 in bursts while the FIFOs 136 handle the word-by-word transfer to the destinations. It is presumed in this diagram that the data being written through the write port 71 comes from one of 5 write sources—WA, WB, WC, WD and WE. It is also presumed that the data read from the read port 73 has destinations RA, RB or RC. Transfers between the FIFO's 136 and 138 are shown synchronized in this diagram for simplicity. FIG. 15 omits any refresh cycles, but shows a possible sequence of data transfers.

It is assumed that all contexts except RA have already been initialized. At t₀ RA sends its C_INIT signal. If no other transfer has a higher work value, the SMU 70 selects context RA and starts reading words from the image memory 30 and writing them into the RA FIFO. The memory line shows words RA1-RA6 read during t_{1,} through t₆. Meanwhile, during t₃, destination RB reads out from the RB FIFO word 37. During t₅, source WB writes word 1 to the WB FIFO, and during t₆, source WC writes word 6 to the WC FIFO. During t₇, the SMU 70 writes word 7 into the RA FIFO and RB reads word 38 from the RB FIFO. If the RA FIFO's ceiling threshold is 7 words, ARB 124 will generate a FAULT to stop the transfers for Context RA. The context next in scope is RB.

The next memory cycle (t₈) is the start of a number of memory transfers filling the RB FIFO beginning with word 40. The fact that only 2 words remain in the RB FIFO causes it to have the MAX value of work needing doing, and so be selected by ARB 124. During t_{9,} source WE writes word 30. T₁₂ illustrates that many transfers can happen simultaneously. While word 44 is entering the RB FIFO from the memory, word 39 is being read from the same FIFO to the client context. T₁₄ illustrates that all three SMU ports can be active simultaneously; Source WC writes word 8 to the WC FIFO, destination RA reads word 2 from the RA FIFO and the memory is filling RB FIFO with word 46. From t₁₅ to t₂₆ the transfers between the clients and the FIFOs and the streaming transfers from memory to a Read FIFO continue as described previously.

At memory cycle t₂₇, write source WE sends a FLUSH command. The FLUSH command removes the base threshold restriction for arbitration. When the RA transfer ends at t₃₀, WE is brought into scope. After the last word from WE FIFO is written to image memory 30 at t₃₅, the memory port is shifted to context WC by the ARB124.

The SMU 70 described herein may be implemented in discrete logic, an integrated circuit or in a field programmable gate array device (FPGA). An FPGA having more gates than needed for the SMU 70 alone may be employed. This implementation allows the excess gates of the FPGA to be used for the remainder of the memory control 26 illustrated in FIG. 3. Since the multiplexer 74 and demultiplexer 72 of the memory control are usually specific to a configuration, the common SMU 70 may be easily adapted to various configurations.

Having described preferred embodiments of the invention it will now become apparent to those of ordinary skill in the art that other embodiments incorporating these concepts may be used. Accordingly, it is submitted that the invention should not be limited by the described embodiments but rather should only be limited by the spirit and scope of the appended claims.

1. A memory controller serving a plurality of clients for transferring data between a memory and said plurality of clients, each client of said plurality of clients transferring data for one or more contexts identified by a corresponding context code, said memory controller comprising:
a unified buffer adapted to store context identified write data and context identified read data organized by context;
a write port adapted to receive context identified write data from said plurality of clients and store it in said unified buffer;
a read port adapted to provide context identified read data to said plurality of clients from said unified buffer;
a memory port adapted to transfer data between said memory and said unified buffer, wherein memory addresses of said data are related to the context of that data;
control and status ports to coordinate the transfer of data between said memory controller and said plurality of clients; and
control logic to allocate access to said memory port among said contexts of said plurality of clients.

2. The memory controller of claim 1 wherein said unified buffer is adapted to function as a plurality of circular double ported FIFO buffers.

3. The memory controller of claim 2 wherein each of said plurality of circular double ported FIFO buffers has an individually specified length.

4. The memory controller of claim 2 wherein said plurality of circular double ported FIFO buffers have a common length.

5. The memory controller of claim 1 wherein said memory addresses are generated by a unified address generator.

6. The memory controller of claim 1 wherein said write port receives said content identified write data in a time-division multiplexed manner and said read port provides said context identified read data in a time-division multiplexed manner.

7. The memory controller of claim 5 wherein said unified address generator incorporates initial context parameter registers adapted to receive initial context parameters from a host processor.

8. The memory controller of claim 7 wherein said unified address generator incorporates a first and a second counter and a look-aside store to store values of said counters based on a context-in-scope, said counters being loaded with a value supplied from said initial context parameters the first time a context becomes the context-in scope, said counters being subsequently loaded from said look-aside store when said context becomes the context-in-scope.

9. The memory controller of claim 8 wherein said initial context parameters include a base memory address.

10. The memory controller of claim 9 wherein said an output of said unified address generator is added to said base memory address.

11. The memory controller of claim 8 wherein said initial context parameters include a first count value and a second count value.

12. The memory controller of claim 8 wherein said initial context parameters include a pool size and a pool base address.

13. The memory controller of claim 8 wherein said initial context parameters include an address decrement indicator.

14. The memory controller of claim 8 wherein said output of said second counter is multiplied by a pitch parameter of said initial context parameters and said second counter is incremented each time said first counter reaches a terminal count.

15. A resource arbitration method for sharing a single resource among a plurality of buffers based on buffer-specific base thresholds, buffer-specific critical thresholds and a selection criterion, said method comprising:
for each buffer, testing whether said buffer has reached said buffer-specific base threshold;
if said buffer has reached said buffer-specific base threshold, calculating a buffer-specific fullness parameter;
selecting a buffer by comparing said plurality of buffer-specific fullness parameters to determine which buffer-specific fullness parameter matches said selection criterion;
outputting a buffer identifier associated with said selected buffer as a resource requested indication;
comparing said buffer-specific fullness parameter of said selected buffer against said buffer-specific critical threshold; and
if said buffer-specific fullness parameter of said selected buffer is less than said buffer-specific critical threshold, generating a fault indication.

16. The method of claim 15 wherein said buffers are first-in-first-out buffers.

17. The method of claim 15 wherein said plurality of buffers are write buffers and said fullness parameter is the number of filled slots in each said buffer.

18. The method of claim 15 wherein said plurality of buffers are read buffers and said fullness parameter is the number of unfilled slots in each said buffer.

19. The method of claim 15 wherein said selection criteria is the maximum.

20. A unified address generator adapted to handle a plurality of contexts comprising:
a set of initial context parameter registers for each of said plurality of contexts;
a unified address generation subsystem;
a set of context working registers for each of said plurality of contexts, said context working registers operative to store a current state of a set of working registers by context each time a generated address changes;
an input from a decision module that initiates a change from a prior context to a new context; and
control logic operative in response to said input to store load the registers of said unified address generation subsystem from said context working registers of said new context.

21. The unified address generator of claim 20 wherein said context initial parameter registers are loaded by a processor interface.

22. The unified address generator of claim 20 wherein said context initial parameter registers contain values for a base address, an address increment value, a pool size, a pool base address, a first counter, a second counter and an line increment value.

23. The unified address generator of claim 20 further comprising an idle state, an armed state, and an operating state for each context of said plurality of contexts.

24. The unified address generator of claim 22 wherein a value derived from said pool size masks the high-order bits of each address generated and said pool base address value replaces said masked high-order bits of the generated address.

25. The unified address generator of claim 23 wherein said multiple contexts enter the armed state simultaneously.

26. A memory sequencer able to provide control signals to a memory wherein multiple contexts are associated with data transferring to memory, said memory sequencer comprising:
a control signal generator operative to cause a data from a source to be written to a memory and said memory to write data into a destination;
a timing signal generator, operative to generate timing signals for controlling a memory transfer, said timing signals optimized for sequential accesses to memory;
a state machine including a state suitable for changing context, said state provided to a memory address generator, said timing signal generator and said source of data; and
an arbiter operative to recognize a requirement that a current memory transfer be interrupted and generate a signal to said state machine to change contexts.
